(19) United States
(12) Patent Application Publication
(10) Pub. No.: US 2009/0096739 A1
(43) Pub. Date: Apr. 16, 2009

(54) LIGHT SOURCE DRIVING CIRCUIT FOR BACKLIGHT MODULE

(75) Inventors: Yu-Chin Lan, Hsinchu (TW); Hui - Chi Chang, Hsinchu (TW); Chien-Chung Hsiao, Hsinchu (TW)

Correspondence Address: J C PATENTS, INC., 4 VENTURE, SUITE 250, IRVINE, CA, 92618, US

(73) Assignee: YOUNG LIGHTING TECHNOLOGY CORPORATION, Hsinchu (TW)

(21) Appl. No.: 12/053,281

(22) Filed: Mar. 21, 2008

(30) Foreign Application Priority Data
Oct. 15, 2007 (TW) 96138498

(51) Int. Cl. G09G 3/36

(52) U.S. Cl. 345/102

(57) ABSTRACT

A light source driving circuit for a backlight module is disclosed, wherein each driving unit includes a reference resistor, a transistor, a bias resistor and a shunt regulator. The transistor is coupled between an LED string and the reference resistor, and the bias resistor is coupled between an operation voltage and the control terminal of the transistor. The shunt regulator is coupled between the control terminal of the transistor and a common terminal, and the reference pin of the shunt regulator is coupled to the common node between the reference resistor and the transistor.

### CROSS-REFERENCE TO RELATED APPLICATION

This application claims the priority benefit of Taiwan application serial no. 96138498, filed on Oct. 15, 2007. The entirety of the above-mentioned patent application is hereby incorporated by reference herein and made a part of this specification.

### BACKGROUND OF THE INVENTION

1. Field of the Invention

The present invention generally relates to a light source driving circuit for a backlight module, and more particularly, to a light source driving circuit for a backlight module employing light emitting diodes (LEDs) as the light source thereof.

2. Description of Related Art

FIG. 1A is a diagram of a conventional light source driving circuit. A light source driving circuit 120 is for driving multiple light emitting diode strings (LEDs strings) 112, 114 and 116, each of which is composed of multiple LEDs. The light source driving circuit 120 is coupled to the cathode terminals of the LED strings 112, 114 and 116 for controlling driving currents passing through the LED strings 112, 114 and 116. The driving circuit 120 is mainly formed by bipolar junction transistors (BJTs) 121-126, where every two BJTs are counted as a set for driving an LED string.

In the conventional structure, all the bases of transistors 121, 123 and 125 are coupled to the cathode terminal P1 of the LED string 112. Although the currents conducted by the BJTs 124 and 126 would be theoretically equal to that conducted by the BJT 122; however, since the amplification ratio β of a BJT has a larger variation and is hard to be controlled, the base current I_{B} of a BJT is quite small and the traces on a printed circuit board (PCB) are quite long, therefore, noise disturbance tends to occur to make the driving currents passing through the LED strings 112, 114 and 116 unequal to each other. In addition, once the voltage in series of the LED string 114 or 116 is greater than that of the LED string 112, it is unable to make the driving current of the LED string 116 or 114 equal to that of the LED string 112, i.e., it fails to achieve a current-averaging function.

FIG. 1B is a statistic diagram of measured currents respectively corresponding to each light source of a set of light sources where the circuit of FIG. 1A is adopted. In FIGS. 1B, R, G and B respectively represent currents passing through red LEDs, green LEDs and blue LEDs and the numbers on the abscissa in FIG. 1B are respectively corresponding to a different light source (for example, the LED strings 112, 114 and 116), wherein a larger number indicates a position of light source is more close to a voltage source. It can be seen from FIG. 1B that the currents distribution of R, G and B are unstable due to a noise disturbance. FIG. 1C is a statistic diagram of measured currents respectively corresponding to each light source of a set of light sources where there is no constant-current circuit. It is clear from FIG. 1C that when there is no constant-current circuit, the distribution of current of R, G and B corresponding to different light sources are not equal to each other, which makes the luminance of LEDs fail to be controlled and leads to un-equalized luminance and poor display quality.

In the prior art, operational amplifiers may also form a light source driving circuit of LEDs as shown by FIG. 2, which is a diagram of a conventional light source driving circuit employing operational amplifiers. In FIG. 2, a light source driving circuit 220 is mainly composed of operational amplifiers and transistors. The current conducted by each of the LED strings 112, 114 and 116 is mainly controlled by a reference voltage VREF and a reference resistor Rref. When a driving current is excessive, the reference resistor Rref would generates a larger voltage difference to make a corresponding operational amplifier output a low voltage level to turn off the transistor.

Although the architecture of the above-mentioned light source driving circuit has an advantage of simplicity, but the driving circuit is hard to be assembled on a circuit board disposed by LEDs in high density distribution due to a larger volume of an operational amplifier. Besides, the current operational amplifiers require a higher reference voltage and have lower accuracy and precision, therefore, it is difficult to make the driving currents of the LED strings 112, 114 and 116 equal to each other.

### SUMMARY OF THE INVENTION

Accordingly, the present invention is directed to a light source driving circuit for a backlight module, which employs metal-oxide-semiconductor field effect transistors (MOSFETs) and a precision shunt regulator to achieve high current-averaging and smaller circuit volume for driving LED light sources.

An embodiment of the present invention provides a light source driving circuit for a backlight module, wherein both terminals of each transistor are connected in parallel to a capacitor to avoid the transistor from abnormal currents due to abnormal charging and discharging so as to assure the current-averaging and dimming functions.

An embodiment of the present invention further provides a light source driving circuit for a backlight module suitable to use an operation voltage for equalizing every current passing through multiple light sources. The above-mentioned light source driving circuit includes a voltage source terminal, a common terminal and multiple driving units, wherein each driving unit includes a reference resistor, a first transistor, a bias resistor and a shunt regulator. The first transistor includes a first output/input terminal to be coupled to one of the above-mentioned light sources, a second output/input terminal coupled to the reference resistor, and a first control terminal for optionally turning on or off the coupling between the first and the second output/input terminals. The bias resistor has an end coupled to the voltage source terminal and another end coupled to the first control terminal of the first transistor. The shunt regulator includes a first electrode coupled to the first control terminal of the first transistor, a second electrode coupled to a common terminal and a reference pin coupled to the second output/input terminal of the first transistor.

When the voltage level of the reference pin herein is equal to or greater than a threshold voltage, the shunt regulator turns on the coupling between the first control terminal of the first transistor and the common terminal so as to turn off the coupling between the first and the second output/input terminals of the first transistor; when the voltage level of the reference pin herein is less than the threshold voltage, the shunt regulator turns off the coupling between the first control terminal of the first transistor and the common terminal so as to turn on the coupling between the first and the second output/input terminals of the first transistor.

In an embodiment of the present invention, each of the above-mentioned driving units further includes a capacitor having an end coupled to the first output/input terminal and another end coupled to the second output/input terminal.

In an embodiment of the present invention, the above-mentioned driving unit further includes a second transistor having a third output/input terminal coupled to the common terminal, a fourth output/input terminal and a second control terminal for receiving a dimming control voltage, and a feedback resistor having an end coupled to the fourth output/input terminal of the second transistor and another end coupled to a ground terminal.

In an embodiment of the present invention, the above-mentioned light source driving circuit farther includes a feedback resistor having an end coupled to the common terminal and another end coupled to a ground terminal.

In an embodiment of the present invention, the above-mentioned light source driving circuit further includes a second transistor having a third output/input terminal coupled to the common terminal, a fourth output/input terminal and a second control terminal for receiving a dimming control voltage.

In an embodiment of the present invention, the first or the second transistor is an MOSFET.

Another embodiment of the present invention provides a light source device for a backlight module suitable to use an operation voltage for emitting even light. The above-mentioned light source device includes multiple light sources, a light source driving circuit, a voltage source terminal, a common terminal and multiple above-mentioned driving units. The voltage source terminal is suitable for providing an operation voltage, while the above-mentioned driving units are respectively coupled between the above-mentioned light source and the common terminal for adjusting and equalizing the current passing through each light source so as to emit even light.

In an embodiment of the present invention, the first or the second transistor is a BJT or an MOSFET.

Yet another embodiment of the present invention further provides a light source driving circuit for a backlight module suitable to use an operation voltage for equalizing every current passing through a light source. The light source driving circuit includes a voltage source terminal, a common terminal and an above-mentioned driving unit, wherein the driving unit includes a reference resistor, a first transistor, a bias resistor and a shunt regulator. The first transistor includes a first output/input terminal to be coupled to one of the above-mentioned light sources, a second output/input terminal coupled to the reference resistor, and a first control terminal for optionally turning on or off the coupling between the first and the second output/input terminals. The bias resistor has an end coupled to the voltage source terminal and another end coupled to the first control terminal of the first transistor. The shunt regulator includes a first electrode coupled to the first control terminal of the first transistor, a second electrode coupled to a common terminal and a reference pin coupled to the second output/input terminal of the first transistor.

When the voltage level of the reference pin herein is equal to or greater than a threshold voltage, the shunt regulator turns on the coupling between the first control terminal of the first transistor and the common terminal so as to turn off the coupling between the first and the second output/input terminals of the first transistor; when the voltage level of the reference pin herein is less than the threshold voltage, the shunt regulator turns off the coupling between the first control terminal of the first transistor and the common terminal so as to turn on the coupling between the first and the second output/input terminals of the first transistor.

In an embodiment of the present invention, since the light source driving circuit for a backlight module employs transistors and a shunt regulator, thus, the driving current of each set of light sources (composed of, for example, an LED string) has a less difference therebetween and the driving circuit has a smaller volume. In addition, in another embodiment of the present invention, since both terminals of each transistor are connected in parallel to a capacitor, the transistor is avoided from abnormal charging and discharging of the parasitic capacitor therein and thereby from causing abnormal currents. In this way, the driving current difference between different LED strings is reduced and the accuracy of adjusting luminance is advanced.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram of a conventional light source driving circuit.

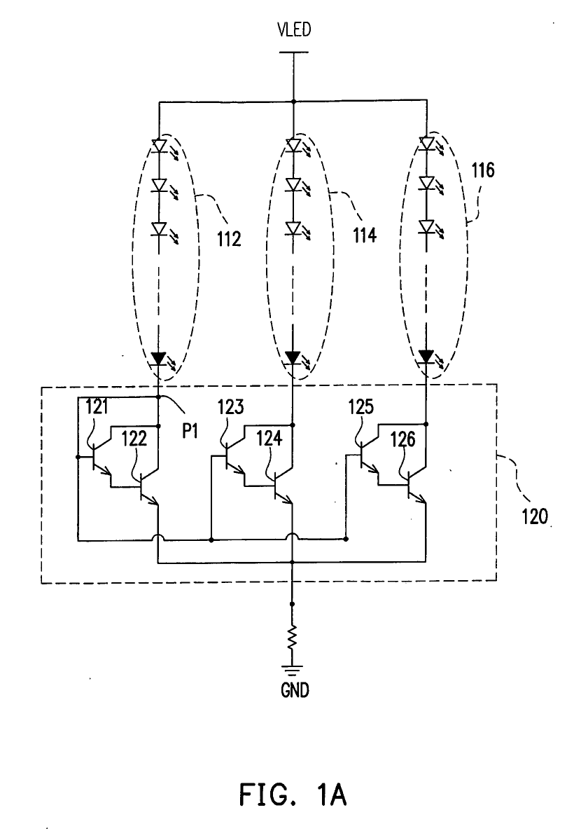

FIG. 1B is a statistic diagram of measured currents respectively corresponding to each light source of a set of light sources where the circuit of FIG. 1A is adopted.

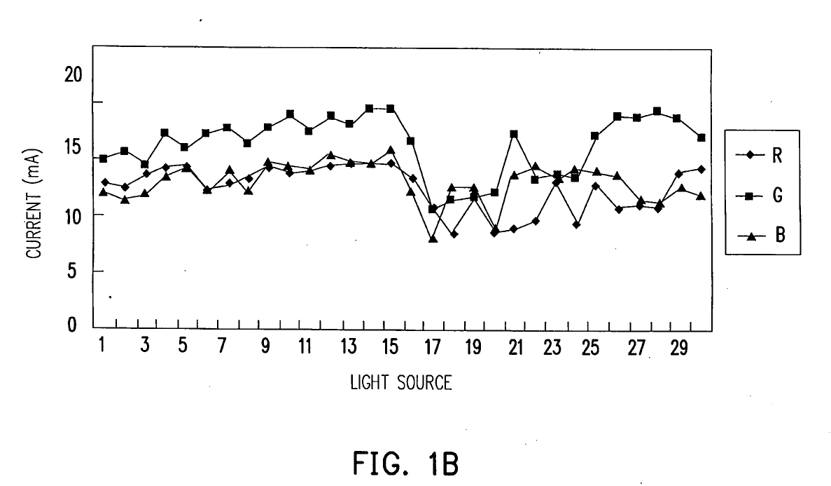

FIG. 1C is a statistic diagram of measured currents respectively corresponding to each light source of a set of light sources where a non-constant-current circuit is adopted.

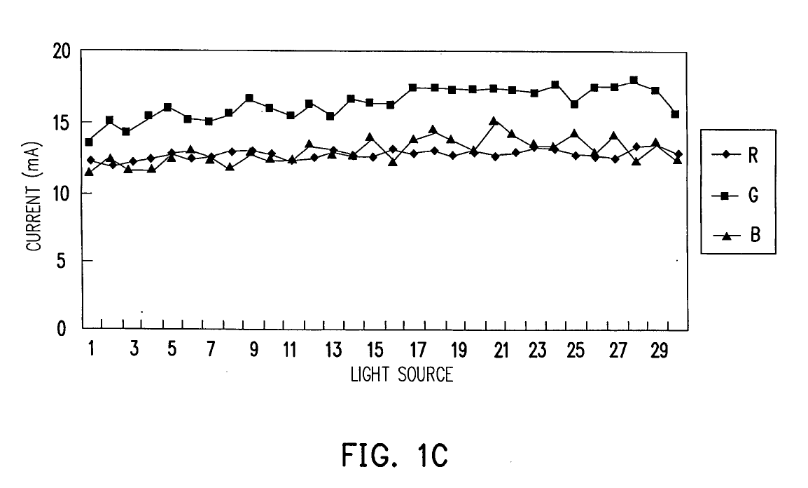

FIG. 2 is a diagram of a conventional light source driving circuit employing operational amplifiers.

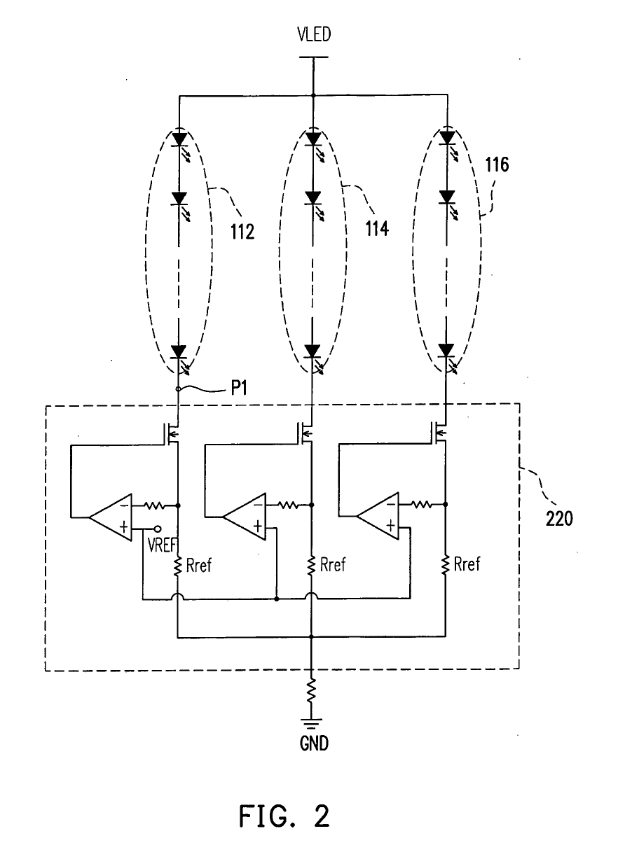

FIG. 3A is a diagram of a light source driving circuit for a backlight module according to the first embodiment of the present invention.

FIG. 3B is a statistic diagram of measured currents respectively corresponding to each light source of a set of light sources where the circuit of FIG. 3A employing BJTs is adopted.

FIG. 3C is a statistic diagram of measured currents respectively corresponding to each light source of a set of light sources where the circuit of FIG. 3A employing MOSFETs is adopted.

FIG. 4 is a diagram of a light source driving circuit according to the second embodiment of the present invention.

FIG. 5 is a diagram of a light source driving circuit with dimming function according to the third embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

### A First Embodiment

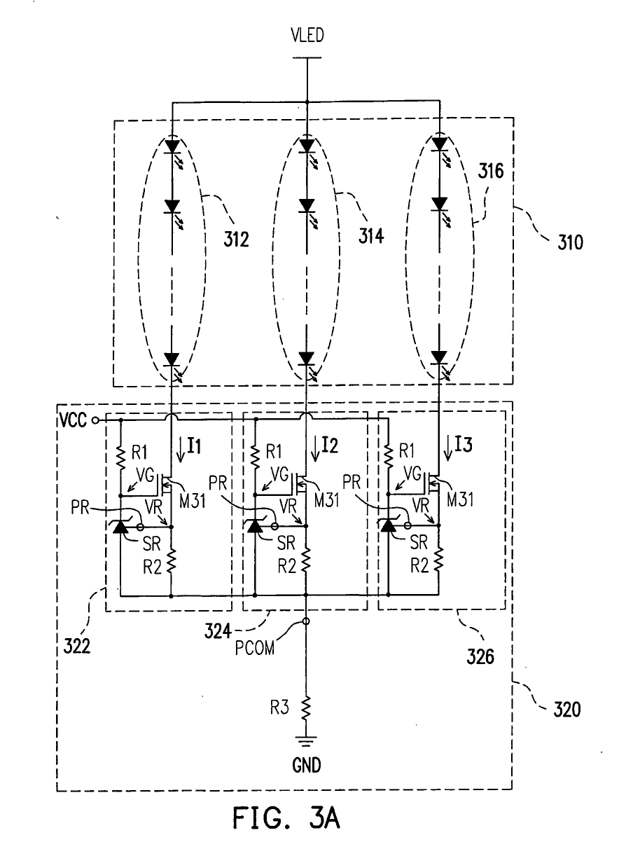

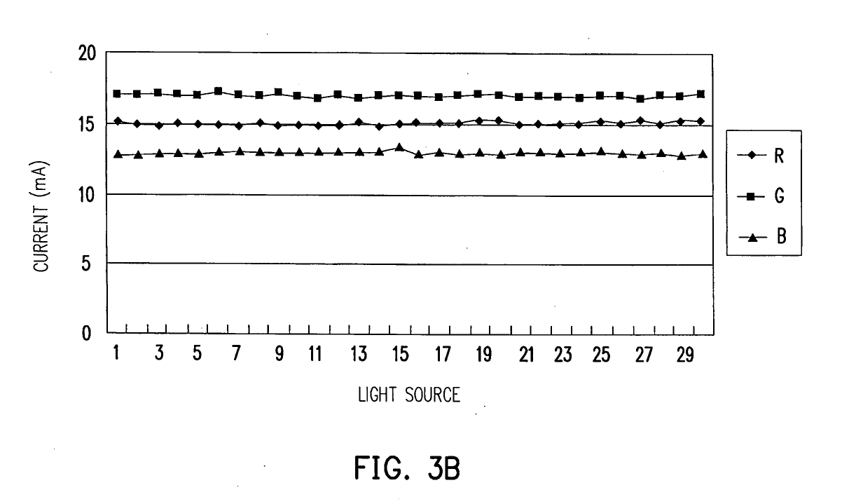

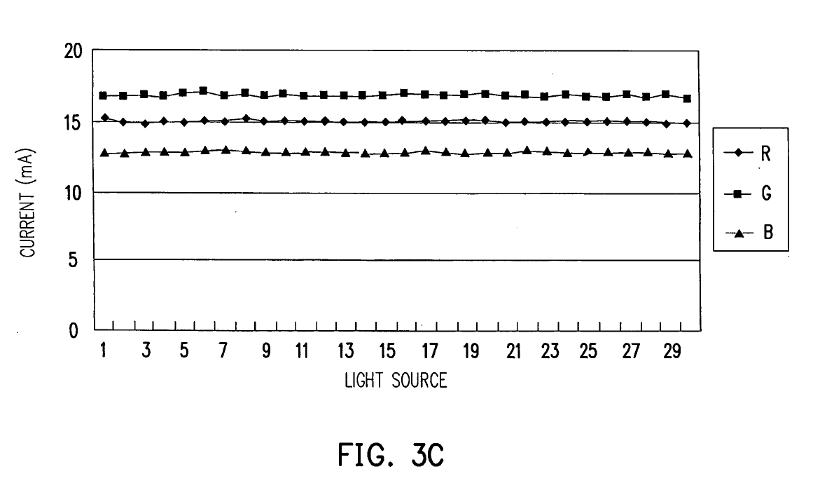

FIG. 3A is a diagram of a light source driving circuit for a backlight module according to the first embodiment of the present invention. Referring to FIG. 3A, a backlight unit 310 includes multiple LED strings 312, 314 and 316 served as light sources, and a light source driving circuit 320 includes driving units 322, 324 and 326 and a feedback resistor R3. Each of the LED strings 312, 314 and 316 is formed by multiple LEDs in series connection. The anode terminals of the LED strings 312, 314 and 316 are coupled to a voltage source VLED, while the cathode terminals thereof are respectively coupled to the driving units 322, 324 and 326 in the light source driving circuit 320. The light source driving circuit 320 herein is mainly for reducing the differences between the driving currents I1, I2 and I3 passing through the LED strings 312, 314 and 316.

The driving unit 322 includes a bias resistor R1, a transistor M31, a reference resistor R2 and a shunt regulator SR. In an embodiment as shown by FIG. 3A, the transistor M31 may be a MOSFET, the source/drain of the transistor M31 is the input/output terminal thereof and the gate of the transistor M31 is the control terminal thereof. Besides in an embodiment, the transistor M31 may be a BJT as well, wherein the collector/emitter of the transistor M31 is the input/output terminal thereof and the base of the transistor M31 is the control terminal thereof.

In FIG. 3A, the first output/input terminal of the transistor M31 is coupled to the cathode terminal of the LED string 312 and the second output/input terminal thereof is coupled to a reference resistor R2; an end of the bias resistor R1 is coupled to a voltage source terminal VCC, and the other end of the bias resistor R1 is coupled to the control terminal of the transistor M31; the cathode of the shunt regulator SR is coupled to the control terminal of the transistor M31, the anode thereof is coupled to a common terminal PCOM, and the reference pin PR of the shunt regulator SR is coupled to the common node of the reference resistor R2 and the second output/input terminal of the transistor M31. The driving units 324 and 326 have the same architecture as that of the driving unit 322 and are respectively coupled between the cathode terminal of the LED string 314 and the common terminal PCOM and between the cathode terminal of the LED string 316 and the common terminal PCOM. The feedback resistor R3 is coupled between the common terminal PCOM and a ground terminal GND.

In order to explain the circuit operation principle of the embodiment, the driving unit 322 is taken as an example. When the shunt regulator SR is off, the voltage VG at the control terminal of the transistor M31 has a high voltage level and the transistor M31 is on. Accordingly, the driving current I1 passes through the transistor M31 and then creates a reference voltage VR at the common node between the reference resistor R2 and the transistor M31. When the reference voltage VR is increased with time to being equal to or greater than the threshold voltage of the shunt regulator SR, the shunt regulator SR is turned on; meanwhile, the voltage VG at the control terminal of the transistor M31 would fall down so as to make the transistor M31 approach closed for reducing the driving current I1. Along with the decreased driving current I1, the reference voltage VR falls down accordingly. Once the reference voltage VR is less than the threshold voltage of the shunt regulator SR, the shunt regulator SR is turned off so that the voltage VG at the control terminal of the transistor M31 is restored to a high voltage level to turn on the transistor M31. During the operation, the shunt regulator SR is repeatedly turned on and off, which enables the driving current I1 to be controlled and thereby take a value around quotient of the threshold voltage of the shunt regulator SR over the resistance of the reference resistor R2.

In the embodiment, the shunt regulator SR is a component with three terminals which include an anode coupled to the common terminal PCOM, a cathode coupled to the control terminal of the transistor M31 and a reference pin PR coupled to the common node between the reference resistor R2 and the transistor M31. The detail specification and the circuit principle of the shunt regulator SR may be referred to the product manuals of the relevant manufactures, for example, the specifications of model TL431 series A and B provided by Semiconductor Components Industries, L.L.C. Company, in 2005, Phoenix, USA, and they are omitted to describe herein for simplicity.

Due to the same circuit architecture the driving units 322, 324 and 326 have, the driving currents I1, I2 and I3 conducted by the driving units 322, 324 and 326 are substantially the same. Therefore, the driving currents respectively passing through each LED of the LED strings 312, 314 and 316 and thus the luminance thereof are also almost equal to each other. The circuit operations of the driving units 324 and 326 are the same as that of the above-described driving unit 322 so that their detailed description is omitted for simplicity.

According to an embodiment of the present invention, the transistor M31 is preferably implemented by a MOSFET. To verify the effect of the embodiment of the present invention, experiments are conducted where light source driving circuits 320 respectively employing BJTs and MOSFETs are used to drive red LEDs, green LEDs and blue LEDs and the currents passing through each LED are measured sequentially at predetermined time points. Referring FIGS. 3B and 3C which are statistic diagrams of measured currents respectively corresponding to the driving circuits of FIG. 3A employing BJTs and MOSFETs, wherein R, G and B respectively represent the currents passing through the red LEDs, the green LEDs and blue LEDs, the numbers on the abscissa are corresponding to different light sources (for example, the LED strings 312, 314 and 316) and a light source with a larger number indicates the light source is located at a place more near to the voltage source VLED.

FIG. 3B shows that the current error rates corresponding to the circuit employing BJTs are respectively R(+1.94%, −1.53%), G(+1.27%, −1.09%) and B(+1.96%, −1.15%), wherein the values in the parentheses respectively represent the max. positive error rate and the max. negative error rate between the measured currents and the ideal current values. So-called current error rate herein is defined as the quotient of a deviation between the current of an LED string from the average current over the average current, i.e., the error rate between the current passing through individual light source (an LED string) and the average current.

FIG. 3C shows that the current error rates corresponding to the circuit employing MOSFETs are respectively R(+1.02%, −1.14%), G(+1.20%, −0.90%) and B(+1.12%, −0.84%). By comparing FIG. 3C with FIG. 3B, it is clear the current error rate corresponding to a light source driving circuit 320 employing MOSFETs is evidently lower than that of BJTs and more constant current outputs, and has better current-averaging effect.

### The Second Embodiment

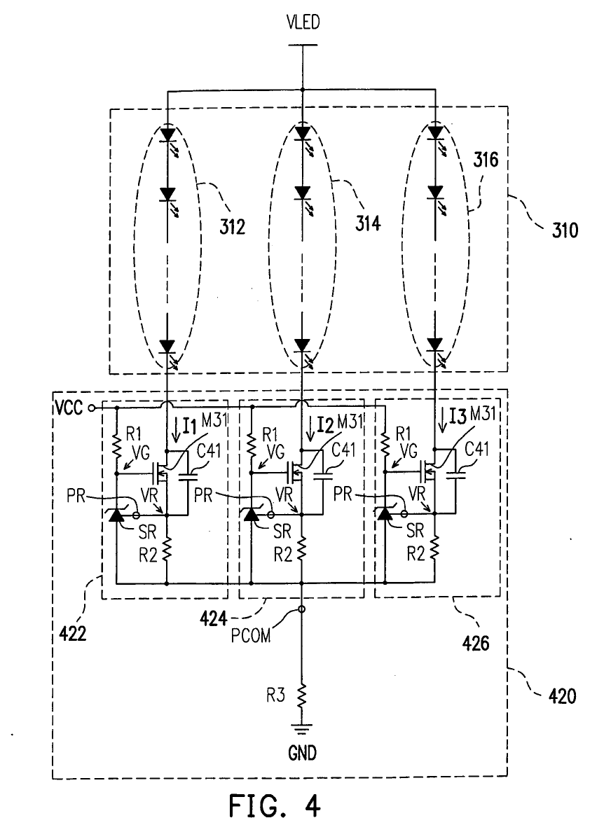

FIG. 4 is a diagram of a light source driving circuit according to the second embodiment of the present invention. The major difference between FIG. 4 and FIG. 3A rests in that each of the driving units 422, 424 and 426 in a light source driving circuit 420 of FIG. 4 includes an additional capacitor C41, wherein a terminal of C41 is coupled to the first output/input terminal of the transistor M31, while another terminal thereof is coupled to the second output/input terminal of the transistor M31.

To obtain different luminance of an LED backlight source, normally, a plurality of LEDs in series connection is used to form an LED string (for example, 312, 314 and 316). However, such a design tends to produce abnormal current waveforms so that the luminance of the LEDs fails to reach the required specification.

The study of the above problem found that the above-mentioned abnormal current waveforms are caused by unmatched impedances between the capacitance of LEDs and the capacitance of transistor M31, and the unmatched impedances are caused by some manufacturing tolerances. The above-mentioned situation makes the capacitors abnormally charge and discharge. To overcome the problem, in the light source driving circuit 420 of the embodiment, an additional capacitor C41 is connected in parallel to every transistor M31, wherein the capacitance of the capacitor C41 is determined by the number of the LEDs in series connection in each of the LED strings 312, 314 and 316, properties of the electric component and the transistor M31. In this way, the impedance matching between the capacitance of LEDs and the capacitance of the transistor M31 is achieved by adjusting the capacitor C41, and the above-mentioned abnormal driving currents due to abnormal charging and discharging of the capacitors may be avoided.

### The Third Embodiment

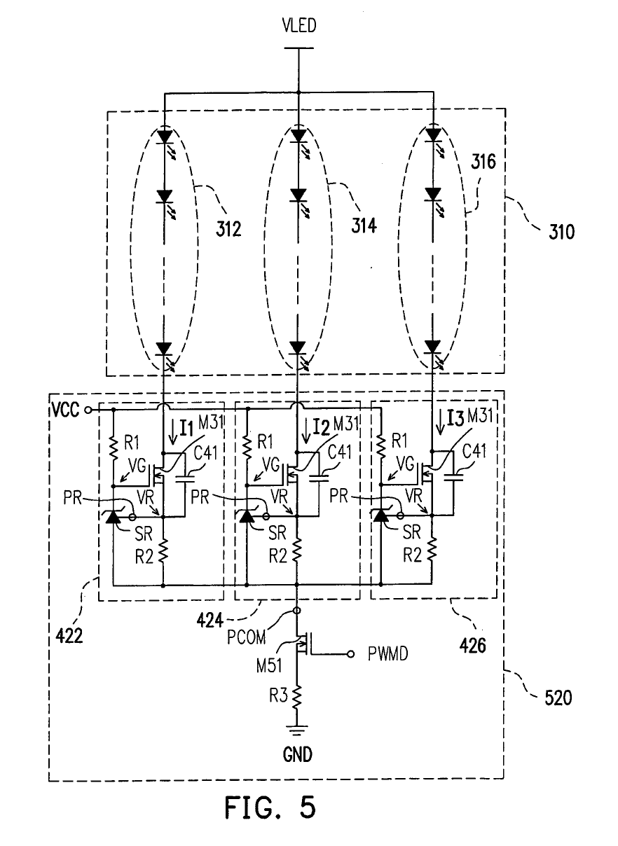

FIG. 5 is a diagram of a light source driving circuit with dimming function according to the third embodiment of the present invention. The major difference between FIG. 5 and FIG. 4 rests in that the circuit of FIG. 5 further employs a dimming transistor M51, wherein the third output/input terminal of the dimming transistor M51 is coupled to the common terminal PCOM, the fourth output/input terminal thereof is coupled to the feedback resistor R3 and the control terminal thereof is coupled to a dimming control voltage PWMD. The dimming control voltage PWMD takes pulse width adjustment mode (PWA mode) to affect the time when the dimming transistor M51 is on for adjusting the amounts of the driving currents I1, I2 and I3 to adjust the luminance of the LEDs in the LED strings 312, 314 and 316 and thereby to achieve dimming function. In the embodiment, a light source driving circuit 520 also employs the capacitor C41 to reduce the impact on the driving currents of the abnormal charging and discharging of the transistor M31.

The circuit architectures of the light source driving circuits provided by the above-described embodiments of the present invention are suitable to drive LED backlight modules in different architectures. Although the above-described backlight unit 310 has exemplarily three LED strings 312, 314 and 316, however, the above-described light source driving circuits do not limit the present invention. For circuit architecture with more or less LED strings, anyone skilled in the art should be able to deduct proper circuit architecture from the disclosed embodiments to meet the requirement of an application.

In summary, since the light source driving circuit for a backlight source employs transistors and shunt regulators, the provided circuit is advantageous in high current-averaging and smaller, circuit volume. Besides, the scheme of using a capacitor connected in parallel to both output/input terminals of a transistor may avoid the abnormal currents caused by the abnormal charging and discharging of the capacitances in the transistor. In this way, the driving current differences between LEDs are reduced so as to exactly achieve desired dimming effect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source driving circuit for a backlight module, suitable to use an operation voltage to equalize each current passing through a plurality of light sources; the light source driving circuit comprising:
a voltage source terminal for providing the operation voltage;
a common terminal; and
a plurality of driving units, wherein each of the driving units comprises:
a reference resistor;
a first transistor, having a first output/input terminal suitable to be coupled to one of the light sources, a second output/input terminal coupled to the reference resistor and a first control terminal for optionally turning on or off the coupling between the first output/input terminal and the second output/input terminal;
a bias resistor, having an end coupled to the voltage source terminal and another end coupled to the first control terminal of the first transistor; and
a shunt regulator, having a first electrode coupled to the first control terminal of the first transistor, a second electrode coupled to the common terminal and a reference pin coupled to the second output/input terminal of the first transistor,
wherein when the voltage level of the reference pin is equal to or greater than a threshold voltage, the shunt regulator turns on the coupling between the first control terminal of the first transistor and the common terminal so as to turn off the coupling between the first output/input terminal and the second output/input terminal of the first transistor; when the voltage level of the reference pin is less than the threshold voltage, the shunt regulator turns off the coupling between the first control terminal of the first transistor and the common terminal so as to turn on the coupling between the first output/input terminal and the second output/input terminal of the first transistor.

2. The light source driving circuit according to claim 1, wherein each of the driving units further comprises:
a capacitor, having an end coupled to the first output/input terminal and another end coupled to the second output/input terminal.

3. The light source driving circuit according to claim 1, further comprising:
a second transistor, comprising a third output/input terminal coupled to the common terminal, a fourth output/input terminal and a second control terminal to receive a dimming control voltage; and
a feedback resistor, having an end coupled to the fourth output/input terminal of the second transistor and another end coupled to a ground terminal.

4. The light source driving circuit according to claim 1, further comprising:
a feedback resistor, having an end coupled to the common terminal and another end coupled to a ground terminal.

5. The light source driving circuit according to claim 1, further comprising:
a second transistor, comprising a third output/input terminal coupled to the common terminal, a fourth output/input terminal coupled to the ground terminal and a second control terminal to receive a dimming control voltage.

6. The light source driving circuit according to claim 5, wherein the first transistor or the second transistor is a bipolar junction transistor.

7. The light source driving circuit according to claim 5, wherein the first transistor or the second transistor is a metal-oxide-semiconductor field effect transistor.

8. A light source device for a backlight module, suitable to use an operation voltage to emit light; the light source device comprising:
a plurality of light sources; and
a light source driving circuit, comprising:
a voltage source terminal for providing the operation voltage;
a common terminal; and
a plurality of driving units, wherein each of the driving units comprises:
a reference resistor;
a first transistor, having a first output/input terminal suitable to be coupled to one of the light sources, a second output/input terminal coupled to the reference resistor and a first control terminal for optionally turning on or off the coupling between the first output/input terminal and the second output/input terminal;
a bias resistor, having an end coupled to the voltage source terminal and another end coupled to the first control terminal of the first transistor; and
a shunt regulator, having a first electrode coupled to the first control terminal of the first transistor, a second electrode coupled to the common terminal and a reference pin coupled to the second output/input terminal of the first transistor,
wherein when the voltage level of the reference pin is equal to or greater than a threshold voltage, the shunt regulator turns on the coupling between the first control terminal of the first transistor and the common terminal so as to turn off the coupling between the first output/input terminal and the second output/input terminal of the first transistor; when the voltage level of the reference pin is less than the threshold voltage, the shunt regulator turns off the coupling between the first control terminal of the first transistor and the common terminal so as to turn on the coupling between the first output/input terminal and the second output/input terminal of the first transistor.

9. The light source device according to claim 8, wherein the light source driving circuit further comprises:
a second transistor, comprising a third output/input terminal coupled to the common terminal, a fourth output/input terminal and a second control terminal to receive a dimming control voltage; and
a feedback resistor, having an end coupled to the fourth output/input terminal of the second transistor and another end coupled to a ground terminal.

10. The light source device according to claim 8, wherein each of the driving units of the light source driving circuit further comprises:
a capacitor, having an end coupled to the first output/input terminal and another end coupled to the second output/input terminal.

11. The light source device according to claim 8, wherein the light source driving circuit further comprises:
a feedback resistor, having an end coupled to the common terminal and another end coupled to a ground terminal.

12. The light source device according to claim 8, wherein the light source driving circuit further comprises:
a second transistor, comprising a third output/input terminal coupled to the common terminal, a fourth output/input terminal coupled to the ground terminal and a second control terminal to receive a dimming control voltage.

13. The light source device according to claim 12, wherein the first transistor or the second transistor is a bipolar junction transistor.

14. The light source device according to claim 12, wherein the first transistor or the second transistor is a metal-oxide-semiconductor field effect transistor.

15. A light source driving circuit for a backlight module, suitable to use an operation voltage to equalize a current passing through a light source; the light source driving circuit comprising:
a voltage source terminal for providing the operation voltage;
a common terminal; and
a driving unit, wherein the driving unit comprises:
a reference resistor;
a first transistor, having a first output/input terminal suitable to be coupled to the light source, a second output/input terminal coupled to the reference resistor and a first control terminal for optionally turning on or off the coupling between the first output/input terminal and the second output/input terminal;
a bias resistor, having an end coupled to the voltage source terminal and another end coupled to the first control terminal of the first transistor; and
a shunt regulator, having a first electrode coupled to the first control terminal of the first transistor, a second electrode coupled to the common terminal and a reference pin coupled to the second output/input terminal of the first transistor,
wherein when the voltage level of the reference pin is equal to or greater than a threshold voltage, the shunt regulator turns on the coupling between the first control terminal of the first transistor and the common terminal so as to turn off the coupling between the first output/input terminal and the second output/input terminal of the first transistor; when the voltage level of the reference pin is less than the threshold voltage, the shunt regulator turns off the coupling between the first control terminal of the first transistor and the common terminal so as to turn on the coupling between the first output/input terminal and the second output/input terminal of the first transistor.

16. The light source driving circuit according to claim 15, wherein the driving unit further comprises:
a capacitor, having an end coupled to the first output/input terminal and another end coupled to the second output/input terminal.

17. The light source driving circuit according to claim 15, further comprising:
a feedback resistor, having an end coupled to the common terminal and another end coupled to a ground terminal.

18. The light source driving circuit according to claim 15, further comprising:
a second transistor, comprising a third output/input terminal coupled to the common terminal, a fourth output/input terminal coupled to the ground terminal and a second control terminal to receive a dimming control voltage.

19. The light source driving circuit according to claim 15, further comprising:
a second transistor, comprising a third output/input terminal coupled to the common terminal, a fourth output/input terminal and a second control terminal to receive a dimming control voltage; and
a feedback resistor, having an end coupled to the fourth output/input terminal of the second transistor and another end coupled to a ground terminal.

20. The light source driving circuit according to claim 15, wherein the first transistor is a metal-oxide-semiconductor field effect transistor.
